(19) United States
(12) Patent Application Publication
(10) Pub. No.: US 2010/0306183 A1
(43) Pub. Date: Dec. 2, 2010

(54) ELECTRONIC SYSTEM FOR A SOCIAL -NETWORK WEB PORTAL APPLIED TO THE SECTOR OF HEALTH AND HEALTH INFORMATION

(76) Inventor: Sandro LACONI, Pula (IT)

Correspondence Address: ABELMAN, FRAYNE & SCHWAB, 666 THIRD AVENUE, 10TH FLOOR, NEW YORK, NY, 10017, US

(21) Appl. No.: 12/713,312

(22) Filed: Feb. 26, 2010

Related U.S. Application Data
(60) Provisional application No. 61/155,647, filed on Feb. 26, 2009.

(51) Int. Cl. G06F 17/30

(52) U.S. Cl. 707/706; 707/740; 707/769; 707/E17.108; 707/E17.09

(57) ABSTRACT

A system for retrieving health-related information includes at least one processor coupled to memory; a back-end subsystem for storing in the memory, illness and health-related information imported from external data-base sources. An information retrieval program stored in the memory is executable by the processor to search the external data-base sources for illness and health-related terms and definitions; organize the illness and health-related information in an internal data-base stored in the memory by categories according to illness names, and include an aggregation of synonyms of scientific and unofficial terms identifying the illness names in different languages; search in each category for health-related articles in at least one predetermined international scientific data-base; and populate the internal data-base with information related to the articles. A front-end subsystem includes a search engine for searching the internal data-base for illness names; and an illness-page module for displaying the results including illness and health-related information and articles.

### CROSS REFERENCE TO RELATED APPLICATIONS

This patent application claims the benefit of U.S. Provisional Application Ser. No. 61/155,647, filed Feb. 26, 2009, the contents of which are incorporated by reference herein in its entirety.

### BACKGROUND OF THE INVENTION

1. Field of Invention

The present invention refers to an electronic system for a social-network web portal applied to the sector of health and health information.

2. Description of the Related Art

Currently, an extremely large number of Internet users browse the web to search for medical information. A hundred and thirty million Europeans (Corriere della Sera, Jun. 14, 2006) look for health and health-related information on the web; 25% of Italians resort to the Internet to obtain information on health questions [source: Censis—Forum per la ricerca Biomedica (Forum for biomedical research), survey: “La nuova domanda di comunicazione sulla salute” (“The new demand for communication on health”) Oct. 3, 2006]; 26% of the searches made on the web in Italy regards health (source: II Sole 24 Ore, Mar. 6, 2007).

Patients or other users browse the web in large numbers to look for specific and reliable information, and are not able to always find specific and reliable information easily. When a person has a health problem, the priority need is that of information, i.e., the need to obtain immediately all the information that can help him to deal with his illness.

The useful information that can help a person to deal with his illness is fundamentally of two types:
medical-scientific information, which must be qualified and updated; and
information regarding experiences of other patients suffering from the same pathological condition, which must be precise and reliable.

These two very different types of information have a single point in common: the same terminology, i.e., the names of the diseases used by physicians. The names in fact are used by physicians both for publishing scientific works in international medical magazines (which are then stored in databases which are accessible via the web, a prime example being Pubmed™), and for providing diagnoses to patients who use the same exact medical terms of illness to search on the Internet for relevant information.

One problem is that when the patients resort to the Internet, they will type the terms of the diseases that have been used by the physicians in their own national language, and this will prevent them not only from accessing the international scientific databases in the case where their own language is not English, but above all from dialoguing with other foreign patients suffering from the same illness, because it will not be sufficient to translate the name of the illness into other languages and go on the Internet either in medical forums and in the other pages that are available on the web in foreign languages. The patient will have no certainty that the translation, however accurate it may be, corresponds to the exact term used by foreign physicians for the same illness. This has so far rendered particularly problematical for users searching relevant information on the web in a foreign language and identifying other foreign web users who suffer from the same illness.

What is currently lacking on the Internet is a complete and coordinated index of the names of the diseases used by physicians in different countries, with the various terminologies in different languages set alongside one another, which will enable a patient to look in his native or national language for both scientific works, most of which are published in English, and for other patients in other countries, and to gain access to information in foreign languages, but with the guarantee that the information regards exactly the illness in question.

In addition, language barriers make it difficult to search medical databases available on various websites, such as the free search engine at Pubmed.gov. Pubmed's website provides databases that enable users to search millions of journal citations and abstracts in the fields of medicine, nursing, dentistry, veterinary medicine, the health care system, and preclinical sciences. The Pubmed™ databases are developed and maintained by the National Center for Biotechnology Information (NCBI), at the U.S. National Library of Medicine (NLM), located at the National Institutes of Health (NIH). However, the inability to perform a search in the native or national language of the user can severely limit the searching process and results. For example, the users cannot consult the databases in their own native/national languages to extract the data which is organized according to key words that are usually within the technical skill of the average user of the Internet including, for example, the names of the diseases communicated by a family doctor that diagnoses an illness.

Further, a user accessing the Pubmed™ database can only retrieve lists of articles sorted by date. As such, the possibility of browsing the Pubmed™ database with more sophisticated keywords, which can be used for refining the search and investigating in greater detail, and which are usually readily understood by the average user, is not currently available. For example, there is a deficiency in the ability to search using key words such as the “Date”, which would serve as a link to go to articles on a specific illness for a specific year, e.g., 2008; by “age classes examined”, which would classify the results based on the age or age groups of the patients; by “type of clinical study”, which can include therapy, diagnosis, etc.; by “type of genetic study”; by “MeSH” (Medical Subject Headings), i.e., to see articles available for each illness, which are ordered according to the related subjects according to the tags that the librarians of the National Library of Medicine attribute manually to each scientific article; by “Magazine”, which would be convenient to see the articles available for each illness ordered according to the magazine in which the article is published, among other key words.

### SUMMARY OF THE INVENTION

The disadvantages heretofore associated with the prior art are overcome by the present invention of an electronic system for a social-network web portal pertaining to the sector of health and health information. More particularly, the present invention is a system for retrieving health-related information, in which in one embodiment, the system comprises at least one processor coupled to a memory, and a back end subsystem for storing in the memory, illness data and other health-related information imported from external data-base sources. The back-end subsystem includes an information retrieval program stored in the memory and executable by the processor, in which the information retrieval program is operable to search in the external data-base sources, illness and health-related information terms and definitions; organize the illness and health-related information in an internal data-base stored in the memory, by categories according to illness names and including an aggregation of synonyms of scientific and unofficial terms identifying the illness names in one or more different languages; for each category, search for health and health information articles in at least one predetermined international scientific data-base; and populate the internal data-base with information related to the articles. A front-end subsystem comprises a search engine, executable by the at least one processor, for searching in the internal data-base for illness names; and an illness page module, executable by the at least one processor to display for any retrieved illness name, one or more illness pages including the illness data, other health-related information, and the information related to the articles.

In one embodiment, the front-end subsystem further comprises a forums module for providing bidirectional exchange of health-related information between users organized by different types of topics.

For each illness name, the categories can include an identifier code, country of origin, and a synonym code. Further, the external data-base sources can include the “International Statistical Classification of Diseases and Related Health Problems, 10th Revision” (ICD10), ICD10 Lists of Tumours, the Orphanet lists of rare diseases, and the illnesses listed in the medical subject headings (MeSH) of the National Library of Medicine (NLM). Moreover, the different languages include English, Spanish, Italian, French and German languages, although these languages are not considered limiting.

Preferably, the at least one predetermined international scientific data-base includes the Pubmed™ data-base, although it is not considered limiting. Further, at least one predetermined international scientific data-base can include classifications of the article based on publication type, language, country, affiliation, author, journal, funding grants, chemical agents cited in the article, and at least one medical subject header. These classifications are also not considered as being limiting.

In another embodiment, the back-end subsystem stores information received from the at least one predetermined international scientific data-base in a form of an XML file. In yet another embodiment, the search engine for searching the internal data-base includes searching criteria to generate the one or more illness pages. The searching criteria can include one or more categories associated with Date of article, age classes examined, type of clinical study, type of genetic study, related subjects; magazine and journals, and authors, although such categories are not considered limiting. Further, the one or more illness pages are divided into information blocks, which include a medical articles block for grouping the related articles, a latest articles published block for including titles of the articles having the most recent date, and an illness study centre for identifying locations of research centres associated with particular illnesses. The information blocks of the illness pages are not considered limiting. In an embodiment, the search engine retrieves the information identifying the articles from the illness page through the medical articles block.

In still another embodiment, the one or more illness pages comprise a community block to activate bidirectional exchange of health-related information between users organized in different types of topics. Further, the bidirectional exchanges can be forums including any one of a hospital forum, a geographic location forum, a pharmaceutical forum and a general forum related to illnesses and health-related information.

In yet another embodiment, the search engine receives search criteria associated with the illness data and other health-related information. The search engine is operable to check if the search criterion is spelled properly; identify related information associated with the search criteria based on phonetics and lexicographical algorithms; and generate alternative search criteria if the originally received search criterion is unsuccessful. In an embodiment, the search engine provides a listing of related articles associated with the search criteria and links for retrieving the articles.

These and further objects are achieved by means of the electronic system as described in the attached claims, which are considered an integral part of the present description.

### BRIEF DESCRIPTION OF THE DRAWINGS

Further advantages and features of the present invention will be readily understood from the following detailed description when considered in conjunction with the accompanying drawings, in which:

FIG. 1 is a block diagram illustrating the primary functional aspects of an electronic system for a social-network web portal of the present invention;

FIG. 2 is a block diagram of an illustrative computer system suitable for use in the electronic system of FIG. 1;

FIG. 3 is a flow diagram representing functional relationships performed by the electronic system of FIG. 1;

FIG. 4 is a first table correlating medical terms in various languages in accordance with the present invention;

FIG. 5 is a second table listing synonyms for the pathological conditions;

FIG. 6 is a flow diagram of a method for populating the database with health related articles and information;

FIGS. 7A, 7B, 7C and 8A, 8B, 8C show diagrams of classes in which the articles are organized in the data-base;

FIGS. 9 and 10 show flow-charts of the way of working of the search engine by which the articles are searched in the data-base; and

FIG. 11 depicts an illustrative page displayed by using the search engine.

### DETAILED DESCRIPTION OF THE INVENTION

In accordance with the present invention, an electronic system providing a social-network web portal includes a database with a compilation of names and associated synonyms for diseases in multiple languages. The list of disease names and synonyms are compiled from various medical databases including, but not limited to, the “International Statistical Classification of Diseases and Related Health Problems, 10th Revision” (ICD10), which is generated up by the World Health Organization (WHO). The ICD10 includes other lists of rare and less rare diseases, such as the ICD10 Lists of Tumours, the Orphanet lists of rare diseases, and the illnesses listed in the medical subject headings (MeSH) of the National Library of Medicine (NLM). The present invention coordinates in a single database a majority of all known diseases which are recognized and published in one or more formats by the most qualified and highly recognized international medical-scientific institutions.

The above-mentioned database currently contains over 166,000 “official” terms for illnesses, which have been coded and associated in a plurality of different languages, such as Italian, English, German, French, and Spanish. The present invention has given rise to national portals (e.g., U.S.A., Japan, Germany, Great Britain, Italy, France, and Spain), which are integrated with one another and enable users to easily search pathological conditions in their native/national language (i.e., any one of the five aforementioned languages that has translated equivalents) to find other patients having the same disease or making the same inquiries regarding a specific illness, and to search and retrieve medical articles and/or journals drawn from the website Pubmed.gov, which is currently the most qualified international scientific database. The aforementioned language and countries are provided for illustrative purposes only and are not considered limiting. For example, as additional terms are translated into other languages, e.g., Japanese, Korean, Russian, among others, a person of ordinary skill in the art will appreciate that additional national portals will be generated, such as in Japan, Korea, Russia, among others.

In practice, when a user (e.g., from one of the illustrative countries listed above) who may not be an expert in the use of the web, types the name of the illness in his own native/national language, the database will be searched using the equivalent English term and consequently the user will be able to consult the contents of the international scientific databases and to contact patients of other nationalities with assurance that they have the same specific illness in common, even though all the patients concerned have typed the name of the illness each in his own language.

On the portal of the present invention, once the specific illness diagnosed by the physician has been typed by the patient in his own language, the patient will gain access to the corresponding web section for more in-depth information where the user will be able to trace:
1. the scientific medical articles specific for his own illness drawn from the most highly qualified and updated international database, namely Pubmed™; the articles will be visible and sortable by a number of characteristics including, but not limited to:
   by Date (with a link it will be possible to go to articles on a specific illness for a specific year, e.g., 2008)
   by age classes examined, by available type of clinical study (i.e. therapy, diagnosis, etc.), by type of genetical study;
   by related subjects, MeSH (it will be possible to navigate among the articles available for each illness through the related subjects, according to the tags attributed by the librarians of the National Library of Medicine to each scientific article)
   by Magazine or Journal (it will be possible to see the articles available for each illness ordered according to the magazine or journal in which the article is published).
2. patients having the same specific illness, with whom the user will be able to communicate and exchange health-related information and experiences both in his own country and, with a simple link, in other countries, by means of forums that are specific according to subject and country.

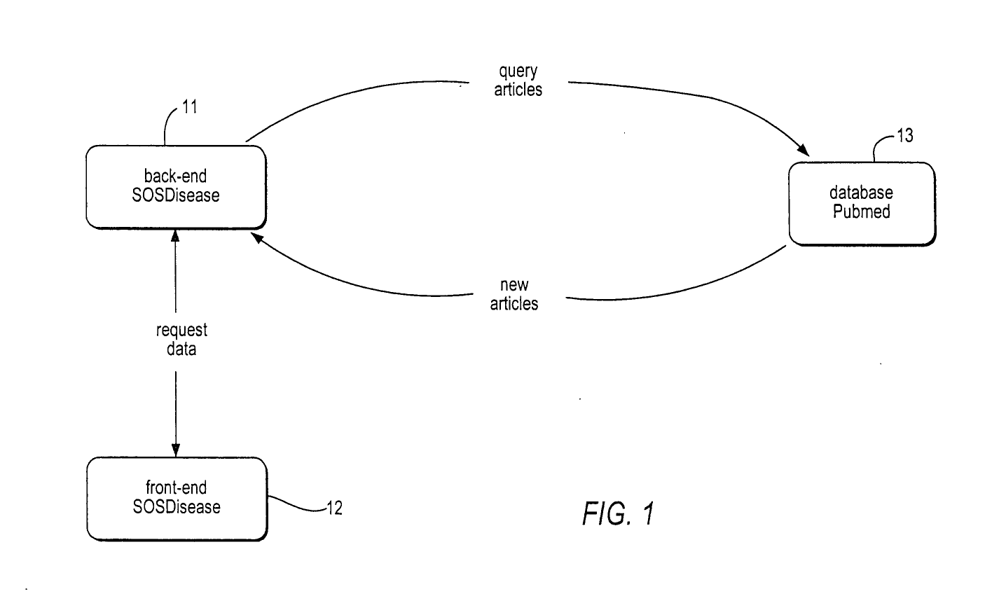

With reference to FIG. 1, the electronic system 1 for a social-network web portal of the present invention includes a back-end subsystem 11 and a front-end subsystem 12. The back-end subsystem 11 is used and controlled by the system operators, and provides for a forward connection to the Pubmed™ data-base 13 to query articles, and a backward connection from the Pubmed™ data-base 13 to retrieve or download the queried articles. The front-end subsystem 12 is for public users of the system, and provides for bidirectional dialog with the back-end subsystem 11.

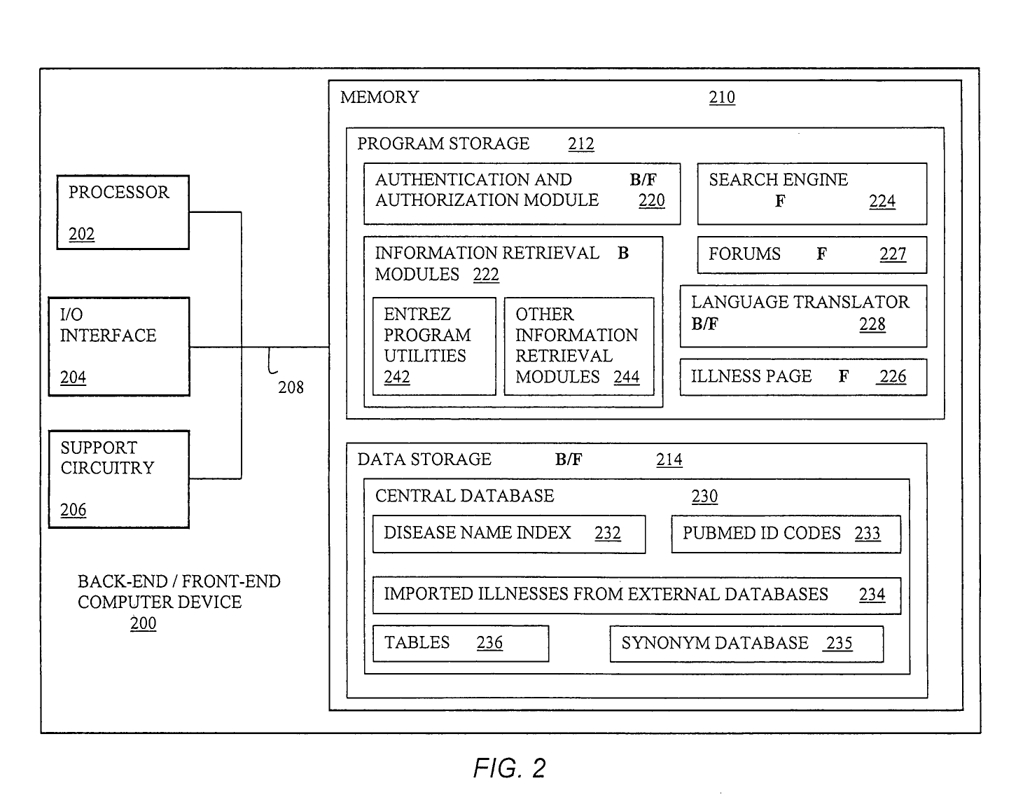

Referring to FIG. 2, the electronic system 1 includes at least one computer device 200 to manage, store data and generally perform various methods for implementing the present invention. In particular, the computer device 200 can be one or more servers that centrally manage the receipt of medical information from the various external medical databases 234 and execute programs to perform database searches to query for specific requested illness information associated with the external medical databases 234. The computer device 200 includes a multitasking, real-time software technology that can concurrently handle hundreds of thousands of queries and updates.

The computer device 200 can be any computer device such as a personal computer, minicomputer, workstation or mainframe, or a combination thereof. While the computer device 200 is shown for illustration purposes as a single computer unit, the system can comprise a group/farm of computers which can be scaled depending on the processing load and database size.

Specifically, the computer device 200 comprises at least one processor 202, as well as memory 210 for storing various control programs 212. The processor 202 may be any conventional processor, such as one or more INTEL™ processors. The memory 210 can comprise volatile memory (e.g., DRAM), non-volatile memory (e.g., disk drives) and/or a combination thereof. The processor 202 cooperates with support circuitry 206, such as power supplies, clock circuits, cache memory, among other conventional support circuitry, to assist in executing software routines stored in the memory 210. The one or more processors 202, memory 210 and support circuitry 206 are all commonly connected to each other through one or more bus and/or communication mediums (e.g., cabling) 208.

The computer device 200 also comprises input/output (I/O) circuitry 204 that forms an interface between various functional elements communicating with the computer device 200. For example, the computer device 200 is connected to a communication link (e.g., the Internet) through an I/O interface 204, which receives information from and sends information over the communication link to various end users 102.

The memory 210 includes program storage 212 and data storage 214. The program storage 212 stores the various program modules of the present invention, an operating system ((O/S) not shown)) such as WINDOWS O/S from Microsoft®, LINUX O/S or any other well-known operating system, among other application programs and data retrieval modules 222.

For example, the program storage module 212 includes sub-modules, such as an authentication and authorization module 220, the information retrieval module 222; a language translation module 228, forum modules 227, and an illness page module 226. The information retrieval module 222 can include sub-modules such as an ENTREZ™ program utility module 242 and other information retrieval modules 244.

The data storage 214 can be an internal or separate storage device, such as one or more disk drive arrays that can be accessed via the I/O interface 204 to read/write data. The data storage 214 includes a central (internal) database 230 which includes database fields, tables, modules or other stored information relating to: a disease name index 232 and identification codes 233 from the World Health Organization (WHO as described below), imported illnesses from the external medical databases 234, a synonym database 235, as well as tables 236 of associations with information taken from external data-bases created by the information retrieval modules 222 in accordance with the present invention, among other information. The central database 230 can be provided internally (as shown in FIG. 2) or externally to the computer device 200. Any of the software program modules in the program storage 212 and data from the data storage 214 are transferred to specific memory locations (e.g., RAM) as needed for execution by the processor 202.

As is described in further detail below, at least some of the sub-modules of the program storage module 212 can be associate with the back-end subsystem (shown with a “B” in FIG. 2), other modules are associated with the front-end subsystem (shown with an “F” in FIG. 2), while still other modules can be related to both back-end and front-end subsystems (shown with a “B/F” in FIG. 2). For example the sub-module authentication and authorization module 220 is related to both back-end and front-end subsystems 11 and 12, as it performs the task of an input port to the system by acknowledging the different privileges of the users (normal users or system administrators). The same applies to the sub-module language translator 228 which manages the translation requests of the system. The search engine 224, the forums 227, the illness page 227 sub-modules pertain to the front-end subsystem 12, while the information and retrieval modules 222 pertain to the back-end subsystem 11. The sub-modules of the data storage module 214 can be related to both subsystems 11 and 12, as indicated by the “B/F” label in FIG. 2).

As such, it is contemplated that some of the process steps discussed herein as software processes may be implemented within hardware, for example, as circuitry that cooperates with the processor 202 to perform various steps. It is noted that the operating system (not shown) and optionally various application programs (not shown) are stored in the memory 210 to run specific tasks and enable user interaction.

The information retrieval module 222 may be used to retrieve information from the externally located Pubmed™ database via the I/O interface 204. The information retrieved by the information retrieval module 222 is stored in the data storage module 214 for further processing. The search engine module 224 accepts search criteria from the user, and uses the search criteria to search the disease name index 232 for matching illnesses.

The operations of the electronic system 1 of the present invention are described below, and are primarily divided between the back-end subsystem 11 and the front-end subsystem 13.

### Back-End Subsystem

The back-end subsystem 11 of the system performs primarily the following operations, as described below:

### Creation of the Lists of the Terms of Illnesses

A single database includes the national lists of illnesses, creating individual lists in various languages, e.g., English, Spanish, German, French, and Italian, with the corresponding hierarchical structure.

The following lists are taken as starting point of the diseases: “international Statistical Classification of Diseases and Related Health Problems 10th Revision” (ICD10), drawn up by the World Health Organization (WHO), ICD10 Lists of Tumours, Orphanet lists of rare diseases, and the illnesses referred to in letters “C” and “F03” of the MeSH of the National Library of Medicine (NLM). The terms are aligned in the various languages in order to create the links that will enable international navigation. The aforementioned sources for the listing of diseases is not considered limiting.

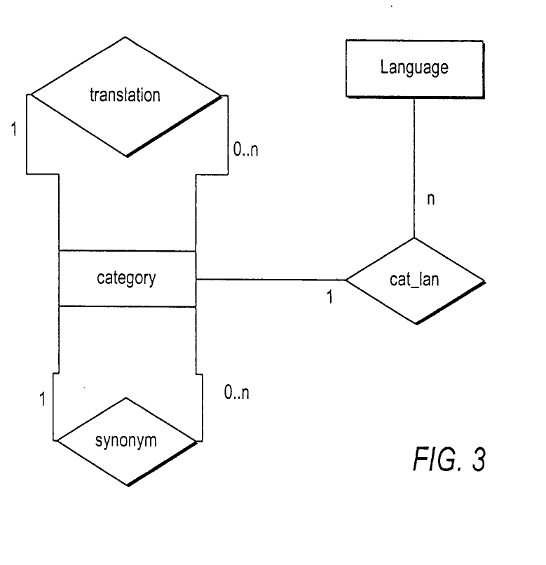

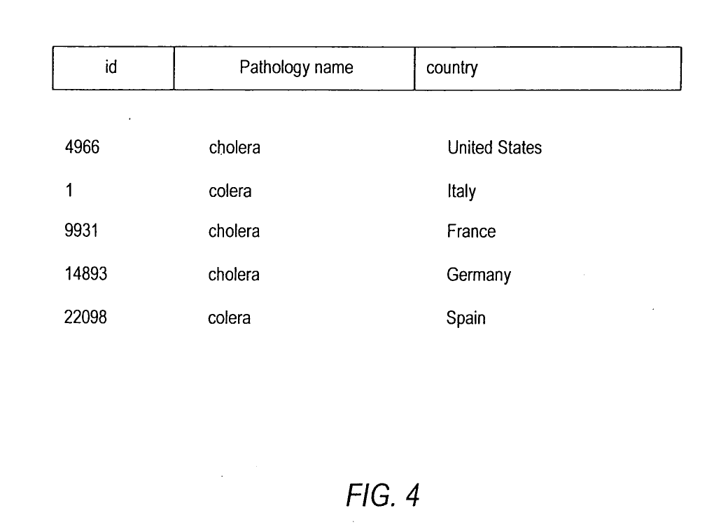

Referring to FIG. 3, the initial operation is to organize the lists of illnesses by “category”, which is constituted by a name of illness, its translations into the various languages, and its synonyms. For example, the category of the illness called “Calera” as expressed in the Italian language has an equivalent translation in English as “Cholera”, in Spanish as “Calera”, in French as “Cholera”, and in German as “Cholera”, as shown in FIG. 4.

### Requisites for Storage of the Illnesses

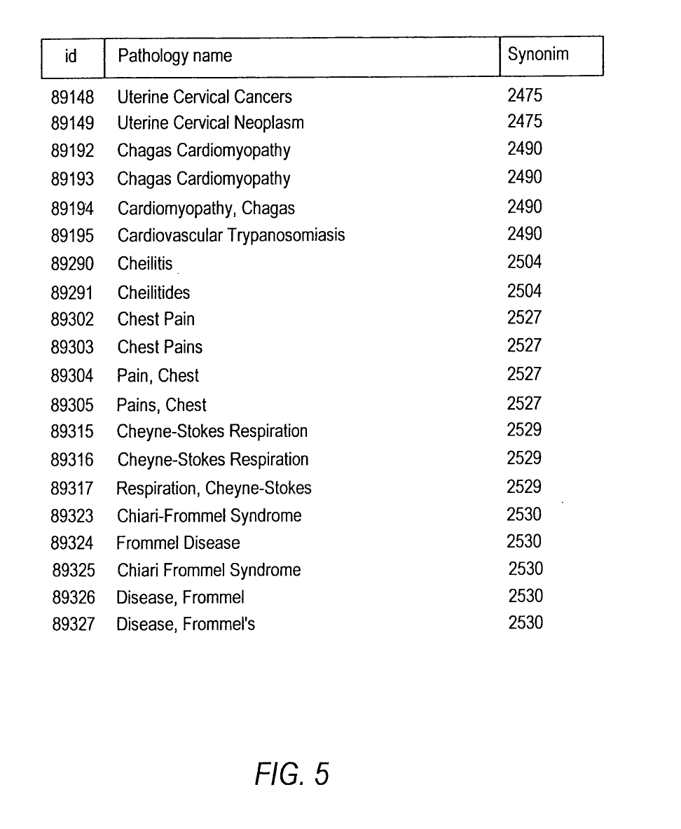

With reference to FIGS. 4 and 5, the information corresponding to the illnesses (pathologies) taken from the aforementioned lists is stored in the database, and organized by the various modules of the present invention into various tables 236 (FIG. 2). For each illness there is saved: the name, the code of the list of origin, the presence of possible synonyms (and possibly the synonyms themselves; for example, for the illness “Viral Encephalitis”, the synonyms “Viral Encephalomyelitis” and “Viral Meningoencephalitis” have been saved), the language of the illness, and the link to the translations of the terms into the other languages.

### Logical Scheme of the Table “Categories”

A first table as shown in FIG. 4 is for storing the language names. A second table as shown in FIG. 5 is for storing the types or names of illnesses. Each entity of the table “Categories” represents an illness in the database. These are characterized by a unique sector ID, by a name and by a code of illness for the corresponding type (ICD10, MeSH, Orphanet, etc.). For each illness name there is an n to 1 association with the table of the languages, meaning that each illness name is associated with one language, and each language is associated with many illness names.

Furthermore, for each illness there may be associated a number of synonyms via the relation “synonym” with the same Table “Categories”, and a number of translations into the other languages via the relation “translation”.

Referring to the table of FIG. 5, the lists can be reviewed by aggregating the synonyms (e.g., “cephalea” and “headache”). Consequently, if a user types the term “headache”, he will consult the databases also for “cephalea”, in English, and a patient who has looked for “cephalea” in Italian will be able to come into contact with a patient who has looked for “headache” in German; the result is aggregated in a Table “categories” to enable proper management of the various links between the terms. In FIG. 5 there is shown an extract of the table that contains illustrative illnesses. The illnesses having an identical code in the column “synonym” are synonyms for such illness name. For example, “Cheyne-Stokes respiration” is synonymous with “Cheyne Stokes respiration”, and “Respiration, Cheyne-Stokes”.

Therefore, the electronic system of the present invention offers a service on the web that enables aggregation of users according to identical illness, even if the illness is sought by each user in his/her own native language. The system provides a list of names of the diseases associated with translations in the various languages.

### Procedure for Populating the Data-Base of Articles.

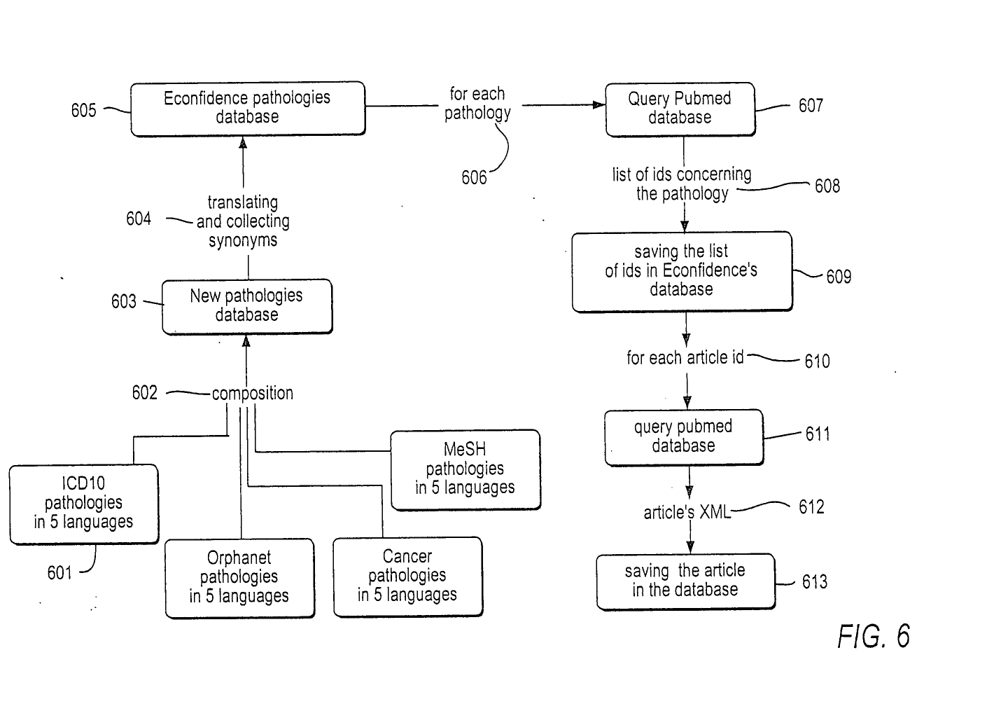

Referring to FIG. 6, the following the procedure is used for populating the database of articles is described, using the modules of the present invention which are provided in the data storage 214 (FIG. 2). The rectangles in FIG. 6 represent processed data or sources, the text outside the rectangles represents operations on the data, and the arrows indicate the processing flow.

More particularly, at step 601, the terms of illnesses are imported from the external databases and stored in memory in database 234. The terms of the illnesses are obtained from the ICD10, drawn up by the World Health Organization (WHO); ICD 10 Lists of Tumours (Cancer pathologies); Orphanet lists of rare diseases; and MeSH illnesses of the National Library of Medicine (NLM).

The translations of the terms of illnesses are stored in a plurality of languages (e.g., Italian, English, French, Spanish, and German). At step 602, the data coming from the four illustrative sources of step 601 are unified in a single database, and at step 603, a new database of illnesses is generated.

At step 604, the synonyms and the translations of the illnesses of the different languages are aligned and stored in memory 235. At step 605, through the passages of the steps set forth above, the new database of illnesses contains the most complete list of illnesses recognized by the international medical institutions translated and aligned in five languages.

At step 606, for each category of illnesses of the list of the illnesses of step 605 deemed interesting for the end user, the Pubmed™ data-base 13 is queried, using the information retrieval modules 222 of the system of FIG. 2, to obtain the list of the article identifier codes related thereto. For this purpose an internal PHP script is provided, such that for each individual term of illness entered, for example “Colera”, following upon the query to Pubmed™, it is possible to obtain the “Pubmed Article IDs”, i.e., the unique identifiers of each individual article that Pubmed™ returns following upon the search made for each term. For each query made to Pubmed™ the PHP script receives in response an xml file.

Pubmed Data-Base Query with Return of Article ID Lists.

The 48,000 names in the English language of the diseases resulting from the procedure referred to above have been searched on the website Pubmed.gov by using the Entrez™ program utilities of module 222 of FIG. 2, namely the so-called “E-utilities” (http://eutils.ncbi.nlm.nih.gov/Entrez/query/static/eutils_help.html), i.e. the software tools of “professional” query made freely available by Pubmed™.

The “E-utilities”, also known as “Entrez Programming Utilities”, are a well known set of seven tools that are freely available to “advanced” users of Pubmed™. The seven tools of the ENTREZ programming utility include:

EInfo: this tool supplies the number of records indicated in the Pubmed database.

EGQuery: this tool replies to a text query, and returns the number of records that the query requests.

ESearch: this tool replies to a text query, and returns the list of the Pubmed IDs of the articles that satisfy the criteria entered in the query. Further, it returns the translation of the query in the terms that effectively are sought by Pubmed™.

ESummary: this tool replies to a query containing a list of article identifier codes (Pubmed™ Article ID) by returning the summaries of the corresponding documents.

EPost: this tool accepts a list of Pubmed™ Article IDs and returns the corresponding web page;

EFetch: this tool accepts a list of one or more Pubmed™ Article IDs and returns an xml file containing the data of the relevant articles.

ELink: this tool accepts a list of Pubmed™ Article IDs and returns a list of Pubmed™ Article IDs of articles related to the articles that are returned as subject of the query.

An example of query of Pubmed™ through the Entrez™ utilities, in the specific case using ESearch, is the following: http://eutils.ncbi.nlm.nih.gov/entrez/eutils/esearch.fcgi?db=Pubmed&term=cancer&reldate=60&datetype=edat&retmax=10&usehistory=y

This query returns the identifiers of the articles that have to do with the term “cancer” via the parameter “term”, in the last 60 days parameter “reldate”, and limits the results to the last 10 parameter “retmax”. The xml file resulting from this query is the following:

<eSearchResult>

<Count>11365</Count>
<RetMax>10</RetMax>
<RetStart>0</RetStart>
<QueryKey>1</QueryKey>
<WebEnv>NCID_1_21578916_130.14.18.52_9001_1266402049</WebEnv>
<IdList>

<Id>20157916</Id>
<Id>20157911</Id>
<Id>20157880</Id>
<Id>20157879</Id>
<Id>20157877</Id>
<Id>20157867</Id>
<Id>20157846</Id>
<Id>20157845</Id>
<Id>20157838</Id>
<Id>20157817</Id>

</IdList>
<TranslationSet>

<Translation>

<From>cancer</From>
<To>

“neoplasms”[MeSH Terms] OR “neoplasms”[All Fields] OR

“cancer”[All Fields]

</To>

</Translation>

</TranslationSet>
<TranslationStack>

<TermSet>

<Term>“neoplasms”[MeSH Terms]</Term>
<Field>MeSH Terms</Field>
<Count>2105434</Count>
<Explode>Y</Explode>

</TermSet>
<TermSet>

<Term>“neoplasms”[All Fields]</Term>
<Field>All Fields</Field>
<Count>1653964</Count>
<Explode>Y</Explode>

</TermSet>
<OP>OR</OP>
<TermSet>

<Term>“cancer”[All Fields]</Term>
<Field>All Fields</Field>
<Count>922645</Count>
<Explode>Y</Explode>

</TermSet>
<OP>OR</OP>
<OP>GROUP</OP>
<TermSet>

<Term>2009/12/19[EDAT]</Term>
<Field>EDAT</Field>
<Count>0</Count>
<Explode>Y</Explode>

</TermSet>
<TermSet>

<Term>2010/02/17[EDAT]</Term>
<Field>EDAT</Field>
<Count>0</Count>
<Explode>Y</Explode>

</TermSet>
<OP>RANGE</OP>
<OP>AND</OP>

</TranslationStack>
<QueryTranslation>

(“neoplasms”[MeSH Terms] OR “neoplasms”[All Fields] OR “cancer”[All

Fields]) AND 2009/12/19[EDAT] : 2010/02/17[EDAT]

</QueryTranslation>

</eSearchResult>

With reference to the previous xml code, the following are the meanings of the main fields:

Block 1—the block “count”, which in this case contains the value 11365, indicates the number of results present on the Pubmed database for the query entered. It is the number of results that will be obtained if the query is not limited via the parameter retmax;

Block 2—the second block, “retmax”, indicates the value specified in the string of the query as the maximum limit of results to be returned;

Block 3—the blocks “querykey” and “WebEnv” are used in the case where it is desired to have a fast access to the query in session;

Block 4—the block “IdList” contains as many id blocks as are specified in the parameter retmax. Each id block contains a Pubmed Article identifier which is used in the next step of the procedure to fetch the individual articles;

Block 5—the block “TranslationSet” enables to see how effectively Pubmed™ has translated the query entered to carry out the search within its own database;

Block 6—is the block “TranslationStack”, which shows the steps of generation of the query, i.e., the individual blocks that are used by the Pubmed engine to build up the final query. For example, if the term “cancer” is searched, the engine looks first for “neoplasm” just on the MeSH terms, then for “neoplasm” on all the fields, and finally for “cancer” on all the fields. It then proceeds to the step of concatenation of these blocks via Boolean operators.

Referring back to FIG. 6, at step 607, in response to each query, Pubmed™ returns a file containing the list of the article identifiers (module 233, FIG. 2). At step 608, the list of the article identifiers is saved in the database; by a further script (in the known PHP language), given the xml file containing the list of the articles for the illness in question, the information obtained in response is saved in the database.

At step 609, an archive of the IDs of the articles is obtained regarding the illnesses of interest, the structure of which presents the fields “article ID”, “category identifier”, and “year of publication of the article”. At step 610, for each article identifier, Pubmed™ is queried for the xml file containing the information on the article of interest.

At step 611, Pubmed™ returns an xml file containing the information on the article for each article ID (module 232, FIG. 2). At step 612, the xml file received from Pubmed™ is processed, and the information present in the latter is saved in the tables of the database. For each article ID obtained in the steps previously described, a further PHP script is created, which, after it has verified that the corresponding article is not yet present in the database, downloads from Pubmed™ the corresponding xml file through the utility EFetch that forms part of the Entrez Utilities, processes the contents thereof, and saves it on the database.

The Pubmed™ query for requesting an article through the Entrez utilities is of the type: http://eutils.ncbi.nlm.nih.gov/entrez/eutils/efetch.fcgi?db=Pubmed&id={idArticle}&retmode=xml

where {idArticle} is the identifier of the Pubmed™ article of interest. If, for example, in the preceding passage the value of Pubmed™ article ID “123456” is obtained for an article regarding the illness on which a search is made, the article can be requested via the call to the url: http://eutils.ncbi.nlm.nih.gov/entrez/eutils/efetch.fcgi?db=Pubmed&id=123456&retmode=xml

For each request of the above type, Pubmed™ returns an xml file with the relevant fields of the article. The structure of a generic file is of the type illustrated here below, where there is an xml example for an article returned by Pubmed™ retrieved with the url: http://eutils.ncbi.nlm.nih.gov/entrez/eutils/efetch.fcgi?db=pubmed&id=12345678&retrnode=xml.

<PubmedArticle>

<MedlineCitation Owner=“PIP” Status=“MEDLINE”>
<PMID>12345678</PMID>
<DateCreated>

<Year>1995</Year>
<Month>01</Month>
<Day>04</Day>

</DateCreated>
<DateCompleted>

<Year>1995</Year>
<Month>01</Month>
<Day>04</Day>

</DateCompleted>
<DateRevised>

<Year>2002</Year>
<Month>10</Month>
<Day>04</Day>

</DateRevised>
<Article PubModel=“Print”>

<Journal>

<ISSN IssnType=“Print”>0916-0582</ISSN>
<JournalIssue CitedMedium=“Print”>

<Issue>40</Issue>
<PubDate>

<Year>1994</Year>
<Month>Jun</Month>

</PubDate>

</JournalIssue>
<Title>Integration (Tokyo, Japan)</Title>
<ISOAbbreviation>Integration</ISOAbbreviation>

</Journal>
<ArticleTitle>Denpasar Declaration on Population and
Development.</ArticleTitle>
<Pagination>

<MedlinePgn>27-9</MedlinePgn>

</Pagination>
<AuthorList CompleteYN=“Y”>

<Author ValidYN=“Y”>

<CollectiveName>Ministerial Meeting on
Population of the Non-Aligned Movement (1993:
Bali)</CollectiveName>

</Author>

</AuthorList>
<Language>eng</Language>
<PublicationTypeList>

<PublicationType>Journal Article</PublicationType>

</PublicationTypeList>

</Article>
<MedlineJournalInfo>

<Country>JAPAN</Country>
<MedlineTA>Integration</MedlineTA>
<NlmUniqueID>9001944</NlmUniqueID>
<ISSNLinking>0916-0582</ISSNLinking>

</MedlineJournalInfo>
<CitationSubset>J</CitationSubset>
<MeshHeadingList>

<MeshHeading>

<DescriptorNameMajorTopicYN=“Y”>Developing
Countries</DescriptorName>

</MeshHeading>
<MeshHeading>

<DescriptorName
MajorTopicYN=“Y”>Economics</DescriptorName>

</MeshHeading>
<MeshHeading>

<DescriptorNameMajorTopicYN=“Y”>International
Cooperation</DescriptorName>

</MeshHeading>
<MeshHeading>

<DescriptorNameMajorTopicYN=“Y”>Public
Policy</DescriptorName>

</MeshHeading>

</MeshHeadingList>
<OtherID Source=“PIP”>099526</OtherID>
<OtherID Source=“POP”>00232894</OtherID>
<OtherAbstract Type=“PIP”>

<AbstractText>..... </AbstractText>

</OtherAbstract>
<KeywordList Owner=“PIP”>

<Keyword MajorTopicYN=“Y”>Developing
Countries</Keyword>
<Keyword MajorTopicYN=“Y”>Development
Policy</Keyword>
<Keyword MajorTopicYN=“Y”>Economic
Development</Keyword>
<Keyword MajorTopicYN=“N”>Economic Factors</Keyword>
<Keyword MajorTopicYN=“Y”>International
Cooperation</Keyword>
<Keyword MajorTopicYN=“N”>Policy</Keyword>
<Keyword MajorTopicYN=“Y”>Population Policy</Keyword>
<Keyword MajorTopicYN=“N”>Social Policy</Keyword>

</KeywordList>
<GeneralNote Owner=“PIP”>TJ: INTEGRATION</GeneralNote>
</MedlineCitation>
<PubmedData>

<History>

<PubMedPubDate PubStatus=“pubmed”>

<Year>1994</Year>
<Month>6</Month>
<Day>1</Day>
<Hour>0</Hour>
<Minute>0</Minute>

</PubMedPubDate>
<PubMedPubDatePubStatus=“medline”>

<Year>2002</Year>
<Month>10</Month>
<Day>9</Day>
<Hour>4</Hour>
<Minute>0</Minute>

</PubMedPubDate>
<PubMedPubDate PubStatus=“entrez”>

<Year>1994</Year>
<Month>6</Month>
<Day>1</Day>
<Hour>0</Hour>
<Minute>0</Minute>

</PubMedPubDate>

</History>
<PublicationStatus>ppublish</PublicationStatus>
<ArticleIdList>

<ArticleId IdType=“pubmed”>12345678</ArticleId>

</ArticleIdList>

</PubmedData>

</PubmedArticle>

The example above is a simple xml file, where each block represents a specific section of the document, namely:

PMID: is the Pubmed Identifier. It is a progressive number which uniquely identifies the article in the Pubmed database, and it is the same number present in the query url: http://eutils.ncbi.nlm.nih.gov/entrez/eutils/efetch.fcgi?db=pubmed&id=12345678&retmode=xml

DateCreated: is the date the article was first written, not taking in consideration subsequent modifications or revisions of the article itself.

DateCompleted: is the date of completion of the article.

DateRevised: is the date of the last revision of the article.

Journal: this block contains information concerning the journal which published the article. It contains the ISSN code of the journal, information about the issue (issue number and publication date), the title of the journal, and the ISO (International Organization for Standards) abbreviation of the title of the journal.

ArticleTitle: this is the title of the article.

AuthorList: this block may contain different “Author” blocks, one for each author who took part in writing the article.

Language: this block contains the language in which the article itself was written.

PublicationTypeList: this block contains a list of publication type blocks, where each publication type represents a possible type of publication: electronic, paper, etc.

MeshHeadingList: this block contains a list of MeshHeading blocks where each one represents a Mesh.

Referring to FIG. 6, at step 613, the end result is a database of the Pubmed articles related to each of the illnesses present in the database.

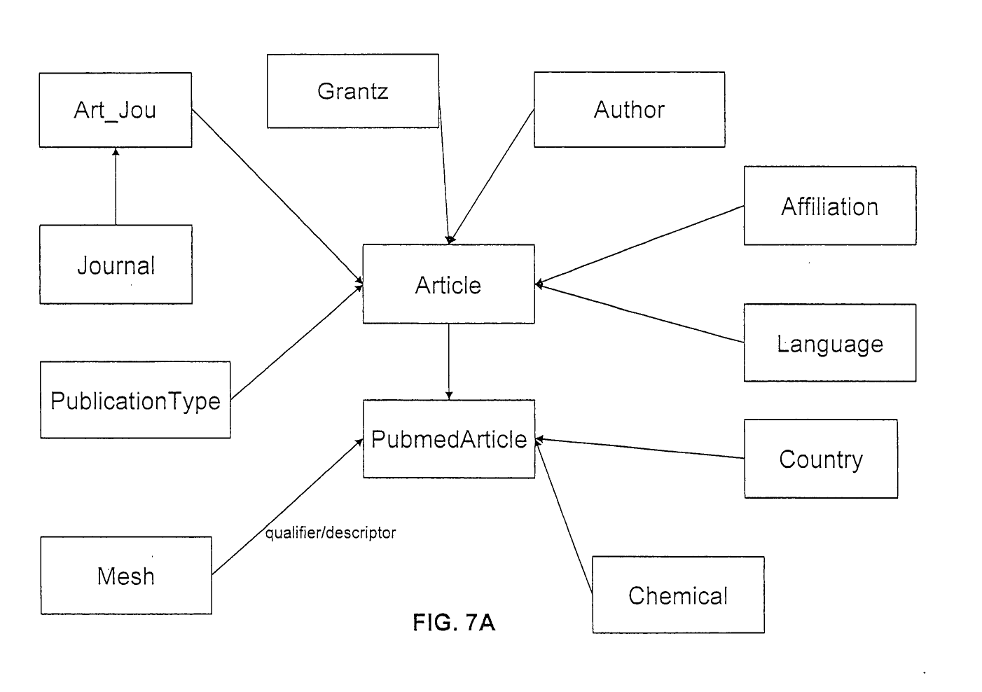

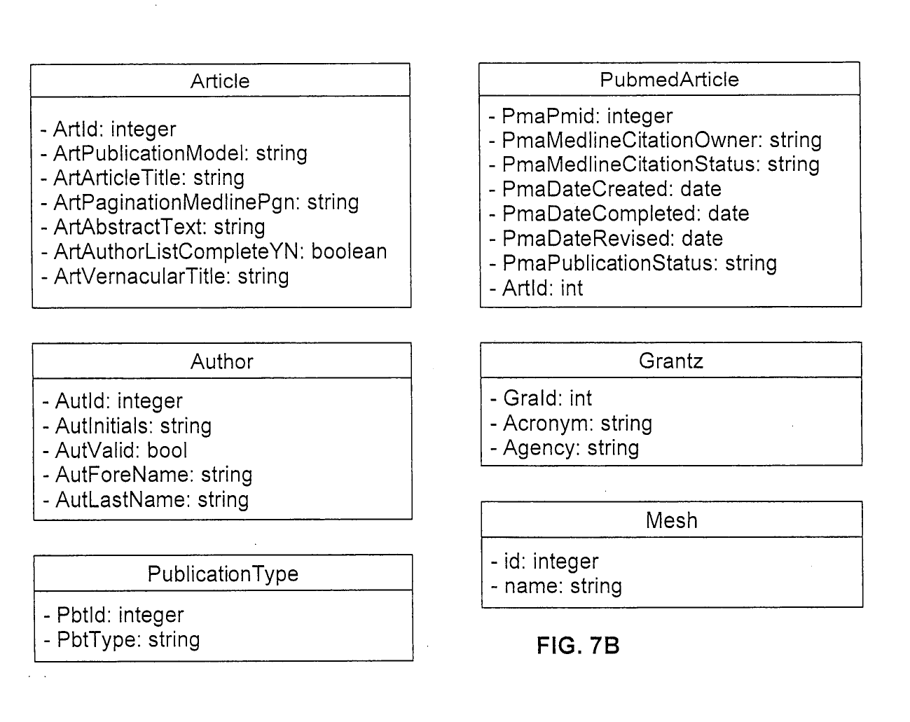

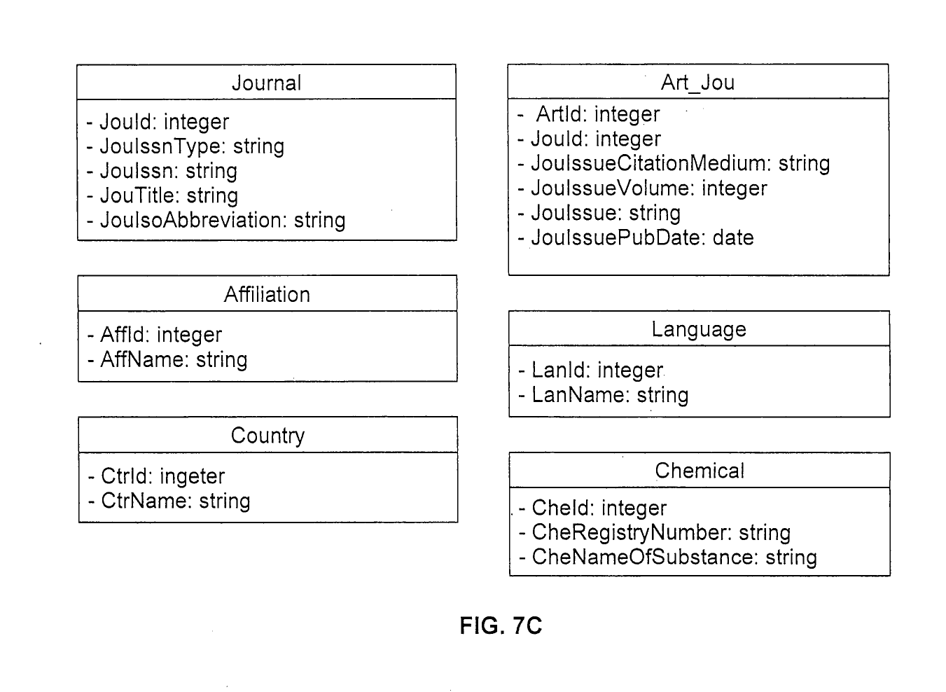

Referring to FIGS. 7A-7C, FIG. 7A illustrates a block diagram of the classes of the Pubmed™ articles, which is the basis of the organization and way of working of the electronic system. FIGS. 7B and 7C illustrate the lists of fields of the relating classes of FIG. 7A. The arrows in FIG. 7A indicate the interrelation among the classes using the symbols of the UML diagram. The names of the classes/objects are as follows:

PubmedArticle: represents the main Pubmed article object, the first field is PmaPMID, which is the same article id as Pubmed. This object can contain the dates of creation, completion and revision of the article.

Article: this object contains the textual data of the article. The important fields include: ArtArticleTitle, which is the title of the article itself, and ArtAbstractText which is the abstract text of the article, where it is present.

Journal: represents a Journal object. A journal is identified by its issn code. It also contains a title and a title abbreviation.

Art_Jou: this object represents the connection between a Journal and an Article. Apart from Artid and Jould which are respectively the id of the article and of the journal, there are: JoulssueCitedMedium, which is the type of medium on which the article appeared; JoulssueVolume, which is the volume on which the article appeared; Joulssue is the issue on which the article appeared; and JoulssuePubDate is the publication date of the journal issue on which the article appeared.

PublicationType: represents the publication type of the article

Author: this class represents an author for the article. It contains a string containing the initials of the author, a Boolean field stating if the author is valid or not and the name and surname of the author. There can be many authors for each article and an author can write many articles, so the connection between Author and Article is saved in a join class (not shown here).

Grants: it is the object representing the funding agency for the research.

Affiliation: this object represents the agency with which the author or authors of the article where affiliated for writing the article.

Language: represents the language of the article itself.

Country: the country where the article was written.

Chemical: a list of chemical agents connected with the article.

Mesh: MeSH is the U.S. National Library of Medicine's controlled vocabulary used for indexing articles for PubMed. MeSH terminology provides a consistent way to retrieve information that may use different terminology for the same concepts. This object represents a mesh for the article itself. Every article can have more than one mesh, and every mesh can be associated with more than one article, so there is a connection class (not present in the diagram) to represent this connection.

By means of the search engine module 224 of the system (FIG. 2), the Pubmed articles, thus entered into the database, enable the user typing the name of the illness in his own native language to browse among them according to:
Date (with a link it is possible to go to articles on a specific illness for a specific year, e.g., 2008)
age classes examined (i.e. 19-44 years);
available type of clinical study (i.e. therapy, diagnosis, etc.),
type of genetical study;
related subjects, MeSH (it is possible to navigate among the articles available for each illness through the related subjects, according to the tags attributed by the librarians of the National Library of Medicine to each scientific article)
Magazine (it is possible to see the articles available for each illness ordered according to the magazine in which the article is published)
Author—it is possible to navigate among the articles according to the author

### Creation of a Library for Pubmed Querying

The library is constructed for ease of use. For example, it can be written in PHP5 language, which is a known object programming language for Web so as to enable to query Pubmed™ and obtain:
the number of the articles present on Pubmed™, with just the name of the illness given as criterion;
the number of the articles present on Pubmed™, with the name of the illness and a time interval expressed as date of start and end given as criterion;
the IDs of the articles present on Pubmed™, restricting the criterion to the name of the illness and to a time interval (in order to be able to update our list of articles conveniently); and
the xmls of the articles of interest.
   Finally, the articles are saved in the database.

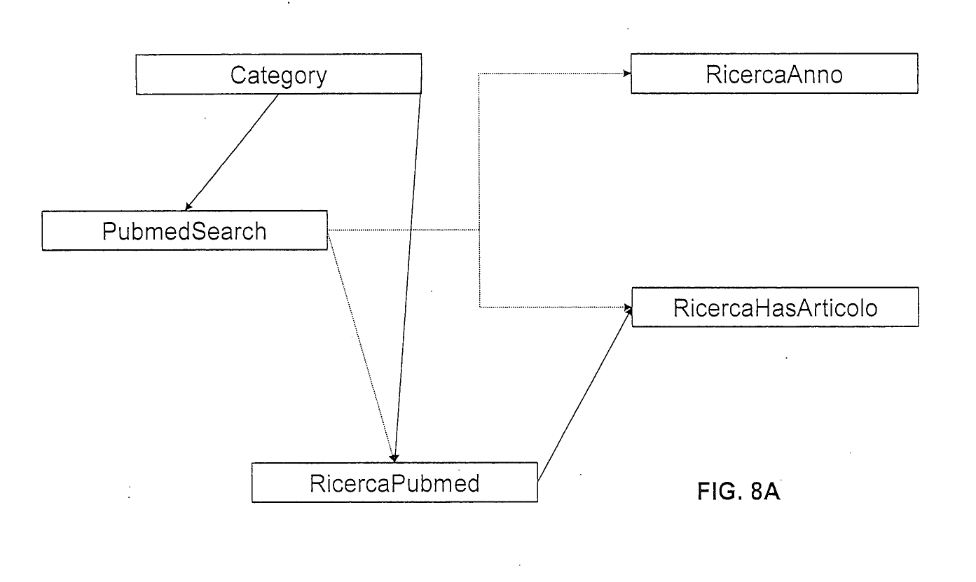

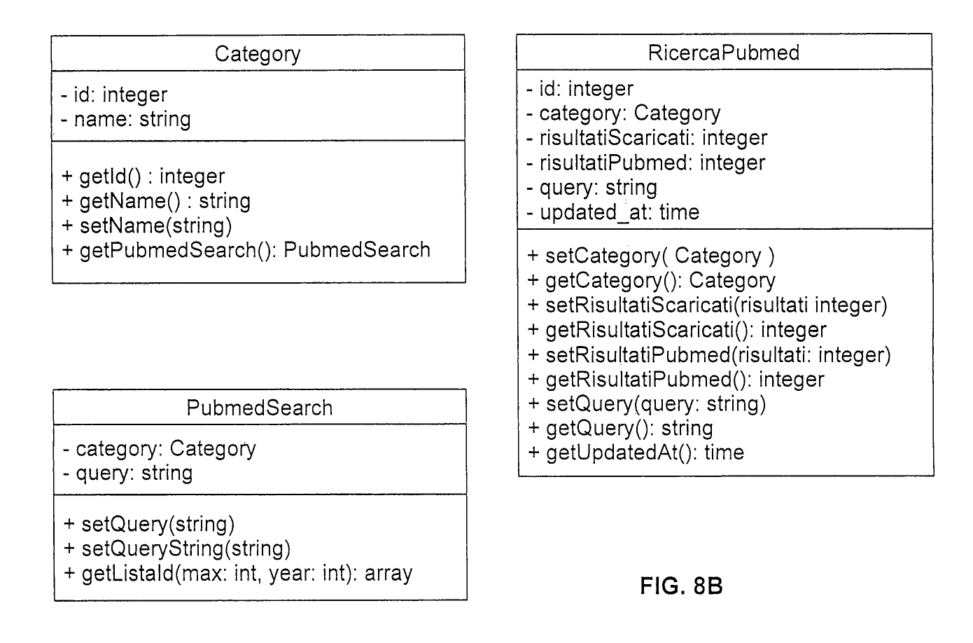

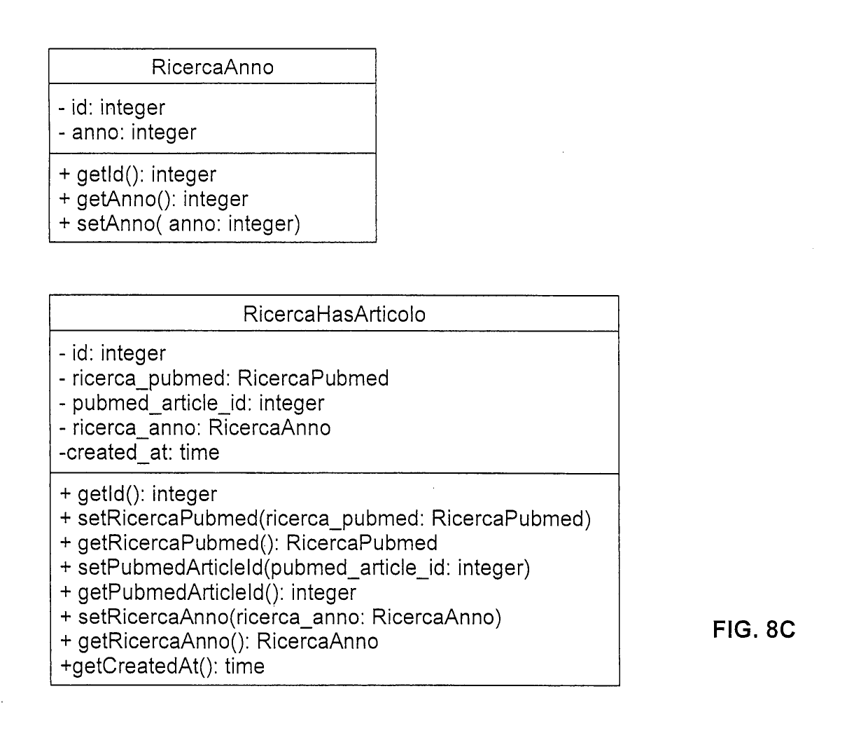

The diagram of the classes useful for searching on Pubmed™, by the information retrieval module 222 of the system (FIG. 2), is of the type illustrated in FIG. 8A. Further, FIGS. 8B, 8C illustrate the lists of fields of the relating classes of FIG. 8A, which are describe in further detail as follows:

Class Category: represents an object of a category type. This object mainly holds the category id (internal on our system) and the Pubmed query string we thought would better fit the specific category;

Class PubmedSearch: is the class that encapsulates the logic that carries out the searches on Pubmed and returns the results from the different kind of queries;

Class RicercaPubmed: represents an object of a result-of-search type that will then be saved in the database. While the PubmedSearch object is the object used to query Pubmed, this object is used to store the results, for example, in English and could be called something like PubmedResult;

Class RicercaHasArticolo: it is the class that links a search to a Pubmed Article ID, and subsequently to an object of a PubmedArticle type (not present in this diagram);

Class RicercaAnno: it is the class that represents an object of a year-search type.

Use of the Pubmed-Search Interface from Class PubmedSearch

The PubmedSearch class is used, through a suitable script, to perform the search for articles relating to the illnesses according to the procedure in the search engine module 224. These articles are extracted from the database via an SQL query of the type: “SELECT c.* FROM categorie as c LEFT JOIN ricerca_pubmed as rp on c.idcategoria=rp.categorie_id WHERE idlingua=1 AND c.flgvendibile=1”;

The script passes an object of Categoria class to an instance of PubmedSearch class, so that we could search the Pubmed database for article Ids related to the illness represented by the Categoria class:

$search=new PubmedSearch( ); //get an instance of PubmedSearch
$search->setQuery($categoria); //pass the Categoria object to the PubmedSearch instance.

Once these two calls have been made, it is sufficient to call the querying methods of the search to obtain the results:

$search->getRecordCount( ) $search->getListald($count,$anno), . . . .

The task of saving the data on the database is left to the classes of model, RicercaAnno, RicercaPubmed and RicercaHasArticolo, which for this purpose use the functions offered by the ORM (Object Relational Mapping) framework Propel (http://propel.phpdb.org)

### Front-End Subsystem

The front-end subsystem of the system performs primarily the following operations, by means of the system modules shown in FIG. 2.

Search Engine

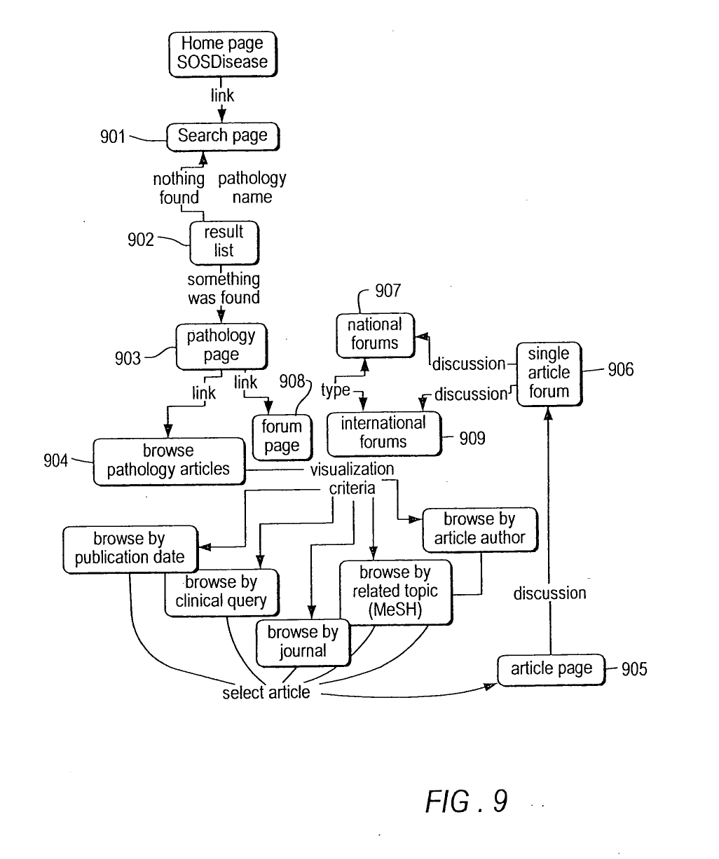

The search engine module 224 is a part of the front-end subsystem 11 of the system 1. The search engine module 224 generates a search tool through a sequence of pages that a user can interface with while viewing on a display. User interaction with the front-end subsystem 11 is described in further detail with respect to FIG. 9.

Referring to the flow diagram of FIG. 9, the first page offered to the user is the search page 901: this page offers a search form consisting of a text field, in which the user can type search criteria, and a button for submitting the search criteria and starting the search.

The search conducted operates on the illness database based of the four sources 601 described above with respect to FIG. 6, and restricts the search only to the native/national language used during navigation by the current user. Hence, if the user is browsing the site in Italian, the search will operate only on the illnesses in Italian. In the case where in the search string there appear words not recognized as illnesses, the system attempts to suggest to the user the word most similar to the one typed using algorithms of phonetic proximity.

If the search is successful a list of the illnesses that satisfy the criterion of search entered is offered to the user (902). By clicking on the name of the illness the “pathology page” 903 is displayed in the language set by the user.

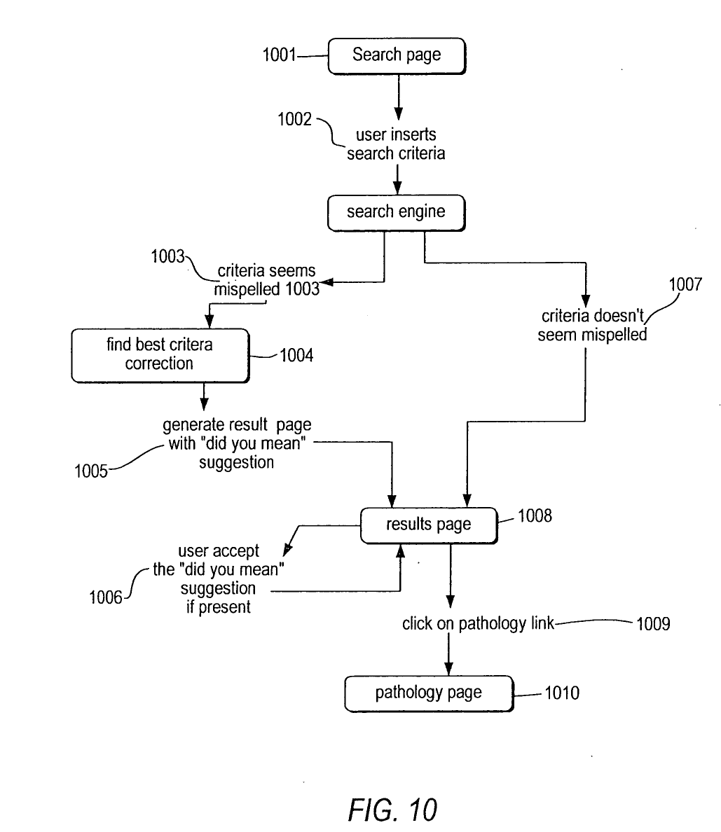

Referring now to FIG. 10, this process is described more in details with reference to the flowchart. At step 1001, the user accesses the home page of the project. At step 1002, the user types a name of an illness in the search form present in the home page of the project and clicks on the “search” button.

At step 1003, the search engine receives the string entered by the user and translates it into a search criterion. The first action taken by the search engine is to check if the search criteria entered by the user is misspelled, at step 1003, or not at step 1007.

At step 1004, the search engine performs a database scan to look for the closer illness to the search criteria by using phonetic proximity (e.g., by using the well-known SoundEx algorithm, among others) and lexicographic algorithms (e.g., calculating the Hamming distance of two words, and the like).

At step 1005, when the search engine finds the closest illness in the database for a mistaken query entered by the user, it generates a result page containing a “did you mean” suggestion which shows closest illness names.

At step 1006, in the result page containing the “did you mean” suggestion the user can accept the suggestion or enter a new search query. If the user accepts the suggestion then the user is redirected to step 1008, otherwise to step 1002.

At step 1008, the search results page offers a list of illnesses that the search engine considered to be matching the search criteria, for each illness is present the number of related articles in the project's database and the date of the last visit. The illnesses are “paginated” so that if the number of matching illnesses is bigger than 20 they are presented in subsequent pages; with a navigation bar in the lower part of the page the user can choose which page to visit.

At step 1009, the user choose a illness name like best matching what he is looking for and clicks on the pathology name. At step 1010, after clicking on the illness name on the result page the user is redirected to the pathology page.

Illness Page (Pathology)

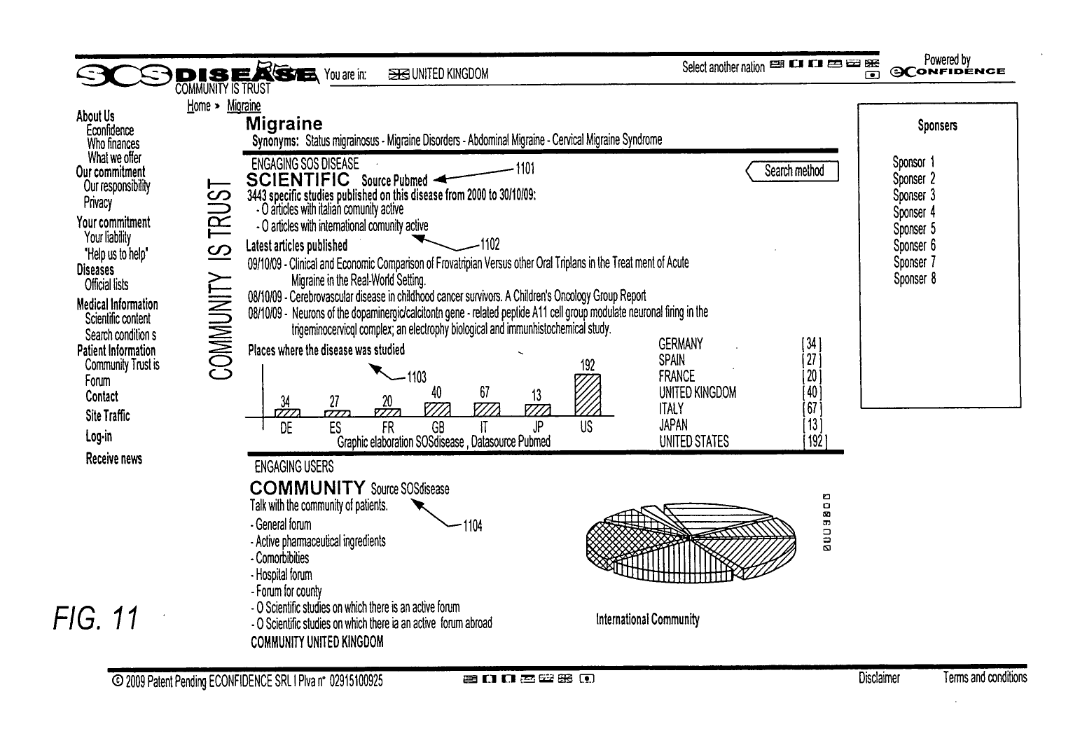

With reference to FIG. 11, an example of illness page is illustratively provided. The illness page is organized for display purposes to the user by the module 226 of FIG. 2.

The illness page is the input port to all the information regarding a given illness. This, in fact, shows some blocks in which the information available for the illness is organized.

Block 1101 “Medical Articles”

This block (articoli medici) shows the articles grouped in the macro-category “medical articles”, with indication of the number of articles available for the illness. By clicking on the link (icon on the right corner of the block), the user reaches the page (in FIG. 10, block 1004) that will enable navigation according to the following keys for consultation of the articles
Date (with a link it is possible to go to articles on a specific illness for a specific year, e.g., 2008),
age classes examined (i.e. 19-44 years),
available type of clinical study (i.e. therapy, diagnosis, etc.),
type of genetical study;
related subjects, MeSH (it is possible to browse among the articles available for the illness of interest by MeSH, i.e., through the related subjects, according to the tags attributed by the librarians of the National Library of Medicine to each scientific article)
Magazine (it is possible to see the articles available for the illness of interest ordered according to the magazine in which the article is published).

Next, the page (FIG. 11) presents the direct links to the articles on which both forums in the user's language and forums in other languages have been activated; by clicking on these links it will be possible to access the page that shows the list of the articles.

Block 1102 “Latest Articles Published”

From the complete list of the articles on the illness returned by the procedure of extraction of the articles from Pubmed for the individual illness, displayed in this block are the titles of the articles having the most recent date (ultimi articoli pubblicati). By clicking on each title of article the user reaches the page where the corresponding article appears.

Block 1103 “Centers where the illness is studied”

This block shows the towns of the current seven nations hosting the research centers performing research on the clinical studies and tests (dove si é studiata la patologia); the information displayed includes where the illness is studied, and sorting the towns by the different classes as described above, it is shown a sort of classification of scientific value, to which a corresponding clinical value is likely to happen.

Block 1104 “Community”

This block comprises the list of the specialist forums for the illness. By clicking, the user goes to the specific forum and on the page the counter of the users that are participating both in the forum in their own country and to the forums in other countries appears.

### Page of Articles According to Illness

By clicking on the link “medical articles published”, the user reaches a page where the Pubmed™ articles can be consulted and explored according to the following search keys (in FIG. 9, block 904):
Date (with a link it is possible to go to articles on a specific illness for a specific year, e.g., 2008);
age classes examined (i.e. 19-44 years),
available type of clinical study (i.e. therapy, diagnosis, etc.),
type of genetical study;
related subjects, MeSH (it is possible to navigate among the articles available for the illness of interest by MeSH, i.e., through the related subjects, according to the tags attributed by the librarians of the National Library of Medicine to each scientific article);
Magazine (it is possible to see the articles available for the illness of interest ordered according to the magazine in which the article is published).

Single Article

By means of the selections described above, the user arrives at a list of individual articles (in FIG. 9, block 905). Each article includes the following fields:
Name of the illness to which the article refers;
Title of the article;
List of the authors of the article (each of which can be further explored to go and see the other articles available in Pubmed™ on the same illness and signed by the same author); by clicking on the name of the author the user accesses a page with the list of the articles written on the same illness and signed by the same author;
Contacts/affiliation: there will be highlighted, in the box “Contacts” the name, locality and addresses for contacting the research centre where the scientific article was written;
Abstract of the article;
Date of publication;
Particulars on the magazine in which the article is published (each magazine can be explored to go and see the other articles available in Pubmed on the same illness and published by the same magazine); by clicking on the title of the magazine the user accesses the page that lists the articles published by the magazine in question on the illness referred to in the article that was being displayed;
List of the MeSH of the individual article (each of which can be further explored to go on to see the other articles available in Pubmed on the same illness which have the same MeSH);
Links for finding on the web the complete text of the article (by solving DOI, PCM and PIO;
Links to the forums regarding the article.

By clicking on a Google Translator button, preferably present on the page, the user can open a pop-up with automatic translation of the text by the Google translation engine.

Referring back now to FIG. 9 and the related forums module 227 of FIG. 2, starting from the article page 905, for each Pubmed™ article it is possible to activate a number of different forums in many languages, one for each of the portals dedicated to the countries involved (single article forum 906), with extremely easy transactional navigation given that it will be possible to see whether on the same article some other country has activated the forum and how many are the subjects involved with whom it will be possible to make contact and exchange information. Therefore, it is possible to activate a national forum 907 if one only country is involved, or an international forum 909 if different countries are involved. It is possible to enter the forums (forum page 908) directly from the pathology page 903.

Furthermore, for each illness, it is possible to activate different types of forums, according to different kinds of topics for discussion. Each of these forums will be replicated in the various specific portals according to nation (e.g., seven nations). The headings for the different kinds of forums can be set by the system operator. For example, the following types of forums can illustratively be initiated:
general: this forum may contain every conversation that will not fit in any other forum, it can be considered as “free discussion forum” about the disease
hospital: in this forum people will be able to talk about topics concerning a specific hospital, there will be a utility to search for hospitals in the nation of the user or in any other nation present in the project. Each discussion will be tied to a specific hospital.
province: in this forum people may speak about topics concerning a specific province, there will be a utility to search for provinces, every discussion will be tied to a specific province.
active pharmaceutical ingredient: in this forum people may discuss about the effects of a specific active pharmaceutical ingredient on their illness. The forum will start with a utility to search for a specific active pharmaceutical ingredient by its atc code (the Anatomical Therapeutic Chemical classification system which is used for the classification of the drugs) or by its name; once the user found the active pharmaceutical ingredient he is interested with he will be able to continue the discussion on it, if one is already present, or start a new one from scratch.
Comorbidities (concomitant pathologies): in this forum people can discuss of illnesses related to the main illness of the forum. People will be able to search for illnesses through a search form. Every time a user opens a new discussion for a concomitant illness the discussion will be present in both the forums of the two illnesses to which the forum is related.

While the foregoing is directed to embodiments of the present invention, other and further embodiments of the invention can be devised without departing from the basic scope thereof, and the scope thereof is determined by the claims that follow.

I claim:

1. A system for retrieving health-related information, the system comprising:
at least one processor coupled to a memory;
a back end subsystem for storing in said memory, illness data and other health-related information imported from external data-base sources;
an information retrieval program stored in the memory and executable by the processor, the information retrieval program operable to:
search in the external data-base sources, illness and health-related information terms and definitions;
organize the illness and health-related information in an internal data-base stored in said memory, by categories according to illness names and including an aggregation of synonyms of scientific and unofficial terms identifying the illness names in one or more different languages;
for each category, search for health and health information articles in at least one predetermined international scientific data-base; and
populate said internal data-base with information related to the articles; and
a front-end subsystem comprising:
a search engine, executable by the at least one processor, for searching in said internal data-base for illness names; and
an illness page module, executable by the at least one processor to display for any retrieved illness name, one or more illness pages including the illness data, other health-related information, and the information related to the articles.

2. The system of claim 1, wherein the front-end subsystem further comprises a forums module for providing bidirectional exchange of health-related information between users organized by different types of topics.

3. The system of claim 1, wherein for each illness name the categories comprise an identifier code, country of origin, and a synonym code.

4. The system of claim 1, wherein the external data-base sources include the “International Statistical Classification of Diseases and Related Health Problems, 10th Revision” (ICD10), ICD10 Lists of Tumours, the Orphanet lists of rare diseases, and the illnesses listed in the medical subject headings (MeSH) of the National Library of Medicine (NLM).

5. The system of claim 1, wherein the different languages comprises English, Spanish, Italian, French and German languages.

6. The system of claim 1, wherein the at least one predetermined international scientific data-base includes the Pubmed™ data-base.

7. The system of claim 1, wherein the back-end subsystem stores information received from the at least one predetermined international scientific data-base in a form of an XML file.

8. The system of claim 1, wherein said at least one predetermined international scientific data-base includes classifications of the article based on publication type, language, country, affiliation, author, journal, funding grants, chemical agents cited in the article, and at least one medical subject header.

9. The system of claim 1, wherein said search engine for searching said internal data-base includes searching criteria to generate the one or more illness pages, the searching criteria comprising one or more categories associated with Date of article, age classes examined, type of clinical study, type of genetic study, related subjects; magazine and journals, and authors.

10. The system of claim 9, wherein the one or more illness pages are divided into information blocks, comprising:
a medical articles block for grouping the related articles,
a latest articles published block for including titles of the articles having the most recent date, and
an illness study centre for identifying locations of research centres associated with particular illnesses.

11. The system of claim 10, wherein said search engine retrieves the information identifying the articles from the illness page through the medical articles block.

12. The system of claim 9, wherein said one or more illness pages comprise a community block to activate bidirectional exchange of health-related information between users organized in different types of topics.

13. The system of claim 12, wherein said bidirectional exchanges are forums including any one of a hospital forum, a geographic location forum, a pharmaceutical forum and a general forum related to illnesses and health-related information.

14. The system of claim 1, wherein said search engine receives search criteria associated with the illness data and other health-related information, said search engine being operable to:
check if the search criterion is spelled properly;
identify related information associated with the search criteria based on phonetics and lexicographical algorithms; and
generate alternative search criteria if the originally received search criterion is unsuccessful.

15. The system of claim 14, wherein said search engine provides a listing of related articles associated with the search criteria and links for retrieving the articles.
